(19) United States
(12) Patent Application Publication
(10) Pub. No.: US 2026/0065714 A1
(43) Pub. Date: Mar. 5, 2026

(54) DEVICE-INDEPENDENT USER AUTHENTICATION

(71) Applicant: Capital One Services, LLC, McLean, VA (US)

(72) Inventors: Sudheendra AYYALASOMAYAJULA, Coatesville, PA (US); Gaurav VERMA, Princeton Junction, NJ (US)

(21) Appl. No.: 18/823,353

(22) Filed: Sep. 3, 2024

(51) Int. Cl. G06V 40/30; G06F 21/32

(52) U.S. Cl. CPC G06V 40/394; G06F 21/32

(57) ABSTRACT

In some implementations, a device may receive, from a user device, a login request to access an account associated with a user. The device may determine device metadata relating to a use of the user device in connection with the login request. The device may determine whether the use is recognized for the user based on the device metadata. The device may cause, responsive to a determination that the use is not recognized for the user, the user device to provide a prompt for inputting a handwriting sample. The device may determine input metadata relating to an inputting of the handwriting sample. The device may determine whether the handwriting sample is valid for the user based on the input metadata and an image of the handwriting sample. The device may authorize the login request responsive to a determination that the handwriting sample is valid for the user.

### BACKGROUND

Multi-factor authentication (MFA) is an authentication technique in which a computing device user is granted access to a resource (e.g., a computing resource, an application, or the like) only after successfully presenting two or more factors to an authentication service. The two or more factors may include knowledge (e.g., something only the user knows), possession (e.g., something only the user has), inherence (e.g., something only the user is), or the like.

### SUMMARY

Some implementations described herein relate to a system for device-independent user authentication. The system may include one or more memories and one or more processors communicatively coupled to the one or more memories. The one or more processors may be configured to receive, from a user device, a login request to access an account associated with a user. The one or more processors may be configured to determine device metadata relating to a use of the user device in connection with the login request, where the device metadata includes one or more of: an orientation of the user device, a touch pressure of inputs to the user device, or a typing speed on the user device. The one or more processors may be configured to determine, using a first user-specific machine learning model, whether the use is recognized for the user based on the device metadata. The one or more processors may be configured to cause, responsive to a determination that the use is not recognized for the user, the user device to provide a prompt for inputting a handwriting sample. The one or more processors may be configured to determine input metadata relating to an inputting of the handwriting sample, where the input metadata includes one or more of: an input pressure used for the handwriting sample or an input speed used for the handwriting sample. The one or more processors may be configured to determine, using a second user-specific machine learning model, whether the handwriting sample is valid for the user based on the input metadata and an image of the handwriting sample. The one or more processors may be configured to authorize the login request responsive to a determination that the handwriting sample is valid for the user.

Some implementations described herein relate to a method of device-independent user authentication. The method may include receiving, by a device and from a user device, a login request to access an account associated with a user. The method may include determining device metadata relating to a use of the user device in connection with the login request. The method may include determining whether the use is recognized for the user based on the device metadata. The method may include causing, responsive to a determination that the use is not recognized for the user, the user device to provide a prompt for inputting a handwriting sample. The method may include determining input metadata relating to an inputting of the handwriting sample. The method may include determining whether the handwriting sample is valid for the user based on the input metadata and an image of the handwriting sample. The method may include authorizing the login request responsive to a determination that the handwriting sample is valid for the user.

Some implementations described herein relate to a non-transitory computer-readable medium that stores a set of instructions for device-independent user authentication. The set of instructions, when executed by one or more processors of a device, may cause the device to determine device metadata relating to a use of a user device. The set of instructions, when executed by one or more processors of the device, may cause the device to determine whether the use is recognized based on the device metadata. The set of instructions, when executed by one or more processors of the device, may cause the device, responsive to a determination that the use is not recognized, to cause the user device to provide a prompt for inputting a handwriting sample. The set of instructions, when executed by one or more processors of the device, may cause the device to determine input metadata relating to an inputting of the handwriting sample. The set of instructions, when executed by one or more processors of the device, may cause the device to determine whether the handwriting sample is valid based on the input metadata and an image of the handwriting sample.

### BRIEF DESCRIPTION OF THE DRAWINGS

FIGS. 1A-1F are diagrams of an example associated with device-independent user authentication, in accordance with some embodiments of the present disclosure.

FIG. 2 is a diagram illustrating an example of training and using a machine learning model in connection with device-independent user authentication, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with device-independent user authentication, in accordance with some embodiments of the present disclosure.

FIG. 5 is a flowchart of an example process associated with device-independent user authentication, in accordance with some embodiments of the present disclosure.

### DETAILED DESCRIPTION

The following detailed description of example implementations refers to the accompanying drawings. The same reference numbers in different drawings may identify the same or similar elements.

Short message service (SMS) one-time password (OTP) is a type of MFA used to verify a user's identity to determine whether to grant a computing device, associated with the user, access to a network resource. SMS OTP typically involves sending a numerical passcode, that is valid for only a short time, to a secondary contact point (e.g., a smartphone) that is known to be owned by the user. The user subsequently enters the numerical passcode into a prompt on the computing device on which the user initially requested access to the network resource.

One problem with SMS-based MFA, such as SMS OTP, is that SMS-based MFA is vulnerable to subscriber identity module (SIM) swapping attacks, in which a malicious actor convinces a telecommunications company that provides service for a victim's mobile device to switch the telephone number for the victim's mobile device from a SIM card in the victim's mobile device to a SIM card in another mobile device. This allows the malicious person to receive all SMS messages and voice calls intended for the victim's mobile device, and thus intercept any one-time passcodes sent via SMS or voice call. If a SIM swapping attack is successful, a malicious actor may gain access to a secure resource (e.g., an online banking account), thereby compromising network security, data security, or the like. Moreover, an entity that maintains the secure resource may expend significant computing resources (e.g., processor resources and/or memory resources) toward identifying security incidents, investigating security incidents, blocking unauthorized access, correcting fraudulent activity, or the like.

Some implementations described herein relate to MFA techniques for user authentication that are device independent. In some implementations, when an individual attempts to log in to an account using a user device, a device that controls access to the account may obtain data indicating the particular way that the user device is being used by the individual, such as an orientation in which the user device is being held, a touch pressure used on the user device, a typing speed used on the user device, or the like. The device may then determine whether this particular use of the user device is consistent with how an authorized user for the account typically uses a user device. Authentication based on how the user device is used, rather than characteristics particular to the user device itself (e.g., operating system version, browser type, or the like), facilitates device independence. In this way, the authentication is resilient to the authorized user changing user devices but can detect when an unauthorized user is attempting to access the account using the authorized user's device or telephone number (e.g., in a SIM swapping attack). Accordingly, techniques described herein provide highly accurate authentication that reduces false negatives.

In addition, if the particular use of the user device is determined to be anomalous (e.g., the use is not recognized as being associated with the authorized user), then a handwriting sample may be collected from the individual using the user device. When the individual inputs the handwriting sample to the user device (e.g., using a touchscreen), the device that controls access to the account may obtain an image of the handwriting sample as well as data indicating the particular way that the handwriting sample is input by the user, such as a touch pressure used on the user device, an input speed used for the handwriting sample, or the like. The device may then determine whether the handwriting sample itself and the particular inputting of the handwriting sample is valid for the authorized user of the user device. Authentication based on the handwriting sample is also device independent, and enables detection of a handwriting sample that appears accurate but was input in a manner that is inconsistent with an authorized user of the account. In this way, the authentication can detect when an unauthorized user is attempting to access the account using the authorized user's device or telephone number (e.g., in a SIM swapping attack) and/or using handwriting forgery.

Accordingly, the user authentication described herein is resilient to SIM swapping attacks or other unauthorized use of a user device or telephone number. Accordingly, techniques described herein improve network security and data security. Furthermore, techniques described herein conserve computing resources (e.g., processor resources and/or memory resources) that otherwise would be used toward identifying security incidents, investigating security incidents, blocking unauthorized access, correcting fraudulent activity, or the like.

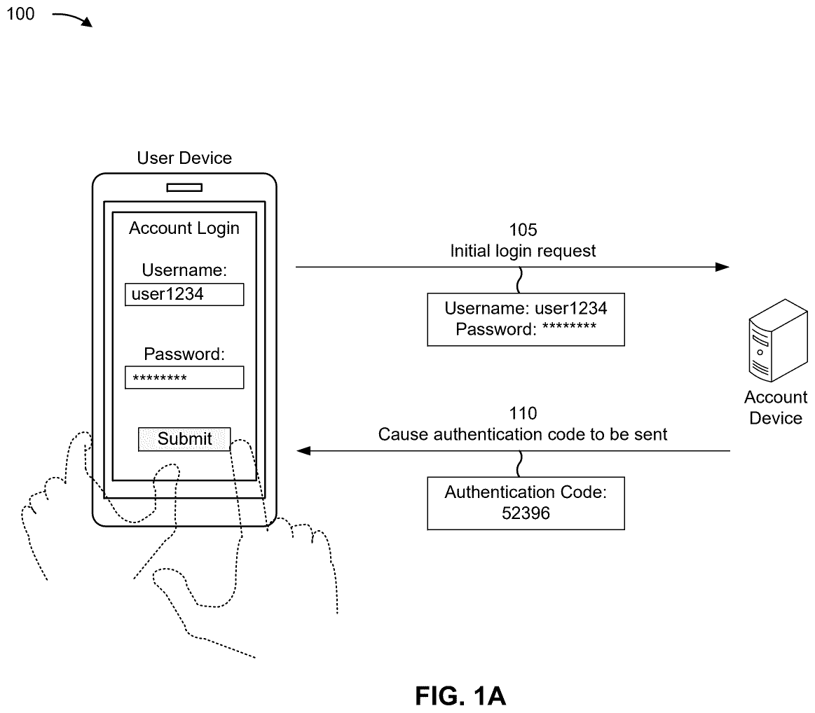

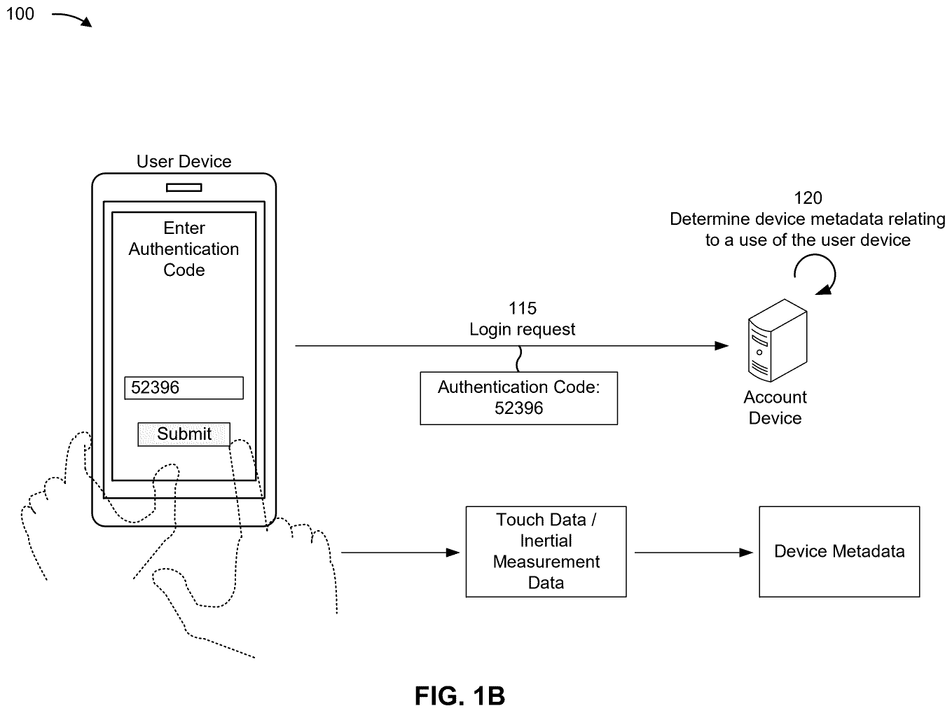

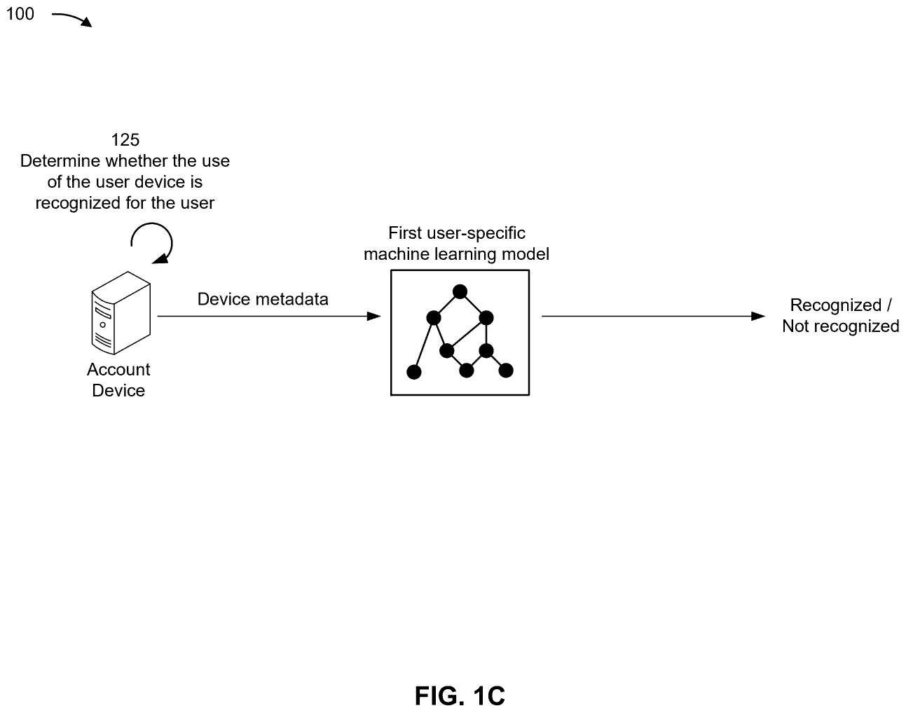

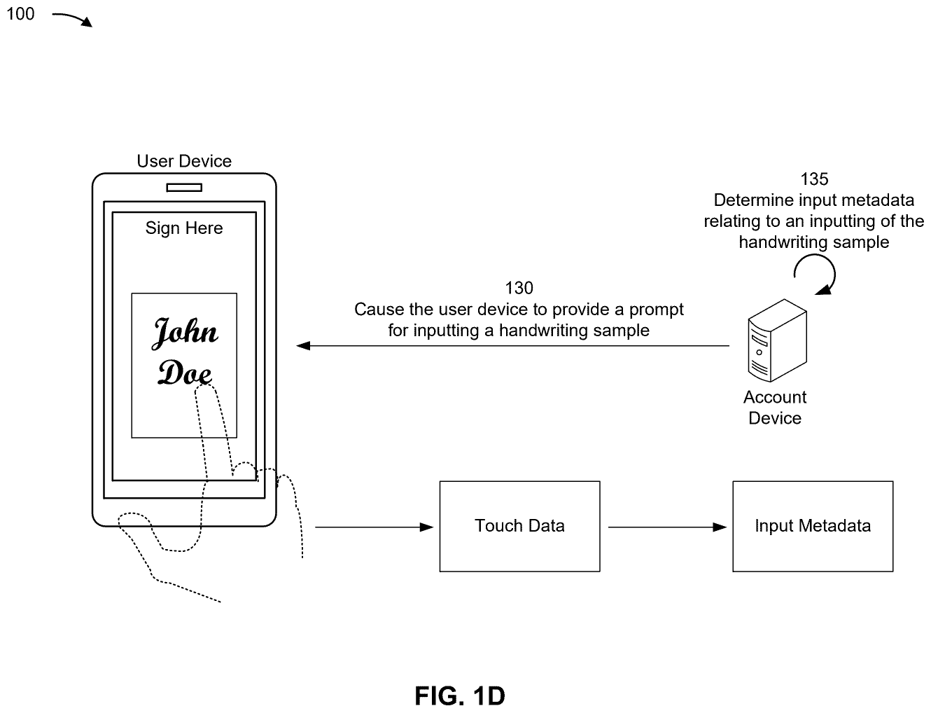

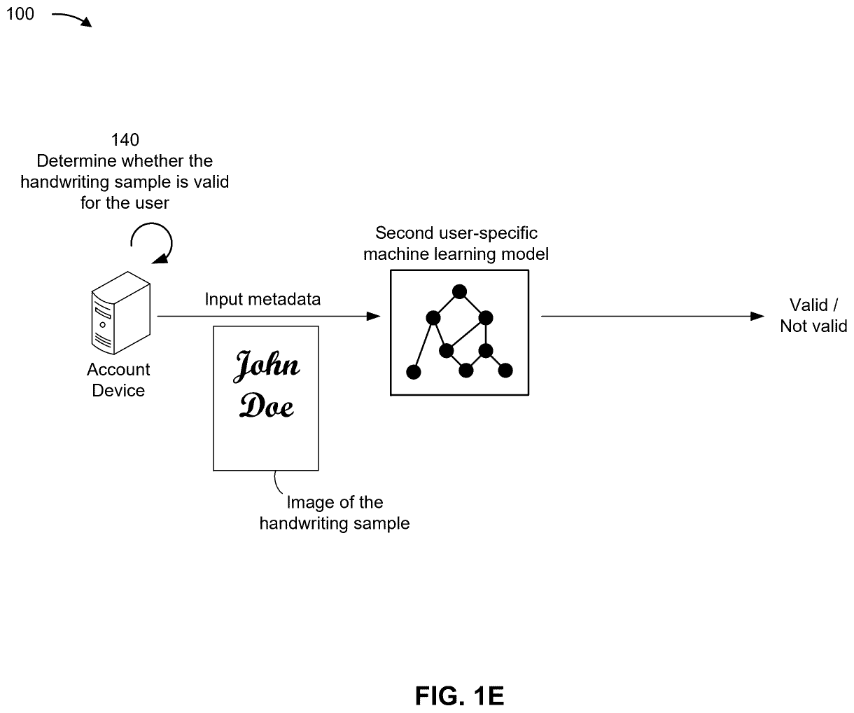

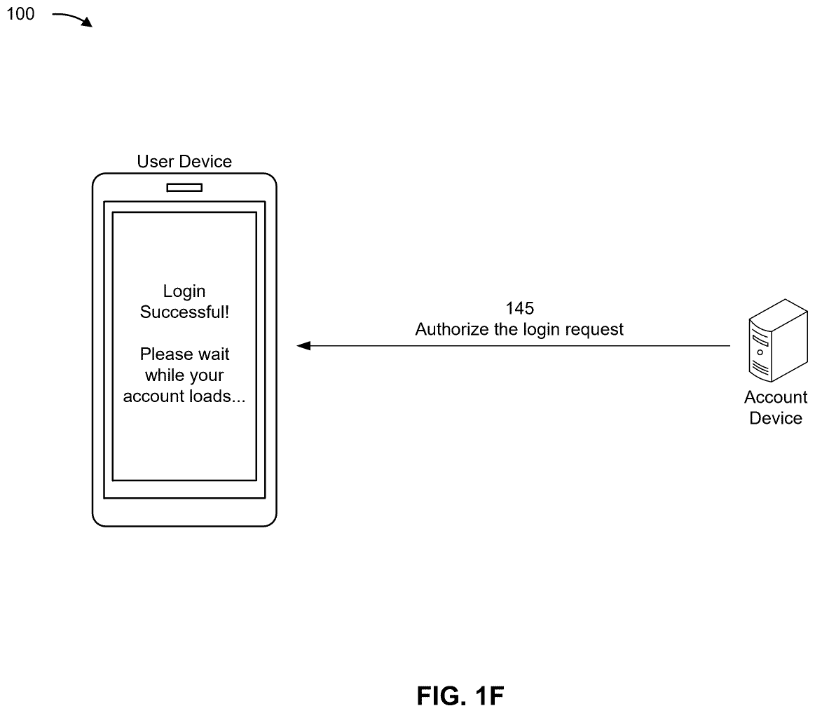

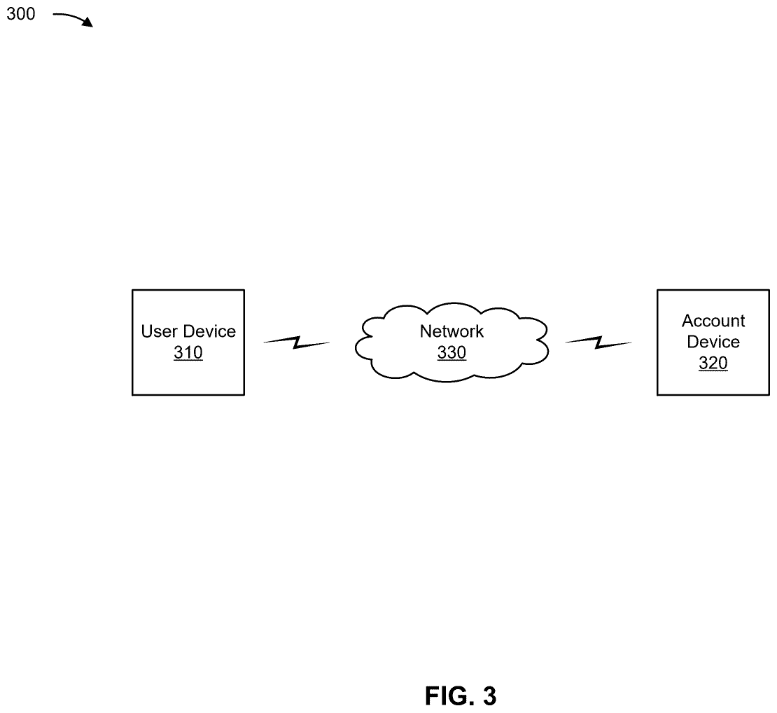

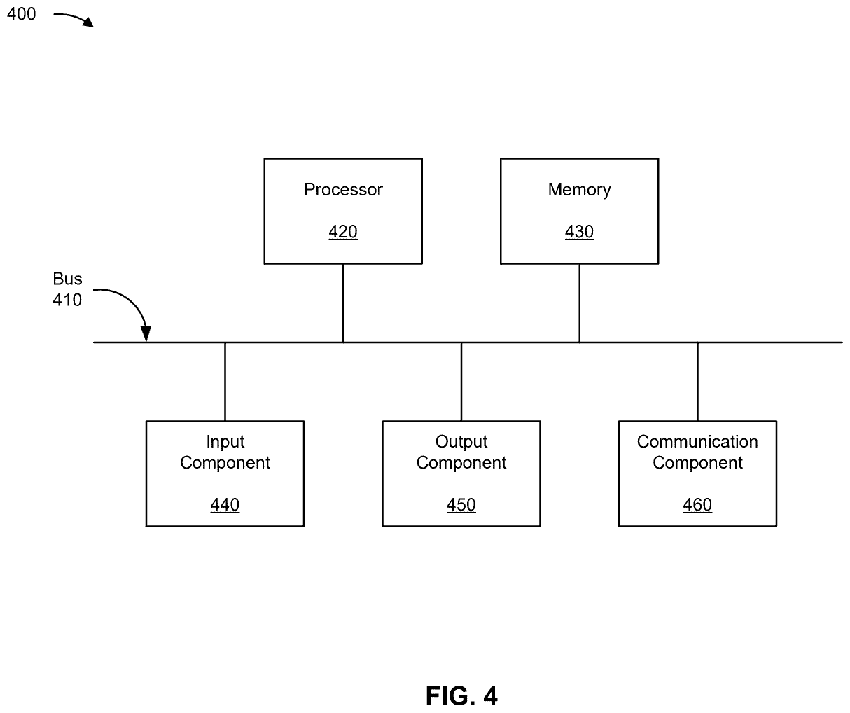

FIGS. 1A-1F are diagrams of an example 100 associated with device-independent user authentication. As shown in FIGS. 1A-1F, example 100 includes a user device and an account device. These devices are described in more detail in connection with FIGS. 3 and 4.

The user device may be associated with an individual. The individual may use the user device to access an account maintained by an entity. For example, the entity may be a financial institution, an email service provider, a cloud service provider, or the like. The account may be associated with an authorized user that is authorized to access the account. For example, the authorized user may have registered the account with the entity. As part of the registration, the user may provide a handwriting sample (e.g., an electronic handwriting sample, provided through an input element of a web page or a mobile application, through a transaction terminal, or the like).

The account device may be associated with the entity that maintains the account. The account device may control access to the account (e.g., to information associated with the account) through a web page, a website, a mobile application (commonly referred to as an “app”), a desktop application, or the like. In order to access the account, the individual using the user device may authenticate with the account device to demonstrate that the individual is the authorized user associated with the account, rather than a malicious actor. Authentication with the account device may involve multi-factor authentication, as described herein. Moreover, in connection with the authorized user registering the account, the account device may initialize one or more user-specific machine learning models for the user, as described below. These machine learning models may be trained over time, as more successful logins to the account occur.

In connection with this authentication, as shown in FIG. 1A and by reference number 105, the account device may receive, from the user device, an initial login request to access the account. For example, the initial login request may indicate one or more textual credentials associated with the user, such as a username, a password, a personal identification number (PIN), and/or an answer to a security question. The account device may compare the textual credentials to a record associated with the user, and the account device may determine whether the textual credentials match those of the record. However, textual credentials are susceptible to misappropriation, and therefore may be insufficient to reliably demonstrate that the individual using the user device is the user associated with the account.

Accordingly, as shown by reference number 110, if the textual credentials match the record, the account device may cause an authentication code to be sent to a telephone number associated with the user. The authentication code may be a one-time password, that is valid for only a single login transaction. The authentication code may include a series of numbers, letters, or a combination thereof. The authentication code may be sent in a text message (e.g., SMS) or a voice call to the telephone number associated with the user (e.g., a telephone number that the user provided in connection with registration of the account). In connection with sending of the authentication code, the account device may cause the user device to provide a prompt (e.g., in a user interface of a mobile application) for inputting the authentication code. While the authentication code provides an additional security layer on top of the textual credentials, the authentication code may lack effectiveness if the user device or the telephone number has been misappropriated by a malicious actor.

As shown in FIG. 1B, and by reference number 115, the account device may receive, from the user device, a login request to access the account associated with the user. For example, the login request may indicate the authentication code sent to the user device. In other examples, the login request may indicate the textual credentials (e.g., the initial login request may not occur). In further examples, the login request may not indicate any security information from the user device. For example, the login request may be a request (e.g., a hypertext transfer protocol (HTTP) request) to access a secure area of a website or a mobile application, among other examples.

As shown by reference number 120, the account device may determine device metadata relating to a use of the user device in connection with the login request. For example, the account device may determine the device metadata responsive to receiving the login request. In particular, the account device may determine the device metadata responsive to the login request indicating a correct authentication code (e.g., the account device may compare the authentication code indicated in the login request to a record indicating the original authentication code that was sent to the user device, and the account device may determine whether the authentication codes match). The device metadata may relate to a time period that includes a time when the user device made the login request. In some implementations, the device metadata may indicate an orientation of the user device, a touch pressure of inputs to the user device, and/or a typing speed on the user device, among other examples.

To determine the device metadata, the account device may obtain touch data (e.g., indicating touch activity, tapping activity, swiping activity, and/or other touch gesture activity on a touchscreen of the user device) and/or inertial measurement data (e.g., gyroscope data and/or accelerometer data indicating orientation activity and/or acceleration activity of the user device), among other examples. For example, the user device may capture sensor data from one or more sensors of the user device (e.g., a touch sensor, a gyroscope, an accelerometer, or the like), generate the touch data and/or the inertial measurement data, and report the touch data and/or the inertial measurement data to the account device. In some implementations, the reported touch data and/or inertial measurement data may be or may include the sensor data.

The account device may analyze the touch data and/or the inertial measurement data to determine the device metadata. In some examples, the user device may analyze the touch data and/or the inertial measurement data, and provide the device metadata to the account device (e.g., to determine the device metadata, the account device may receive the device metadata from the user device). The device metadata may indicate a use profile associated with the user device over the time period that includes the time when the user device made the login request. This use profile may indicate a time series of touch gestures performed on the user device, a quantity of touch gestures performed (e.g., broken down by type of touch gestures), an average touch pressure of the touch gestures, an average touch length of the touch gestures, an average movement distance of the touch gestures, a typing speed on the user device, a time series of orientation angles of the user device, an average orientation angle of the user device, a most-common orientation angle of the user device, a time series of accelerations of the user device, and/or an average acceleration of the user device, among other examples. Thus, the use profile may be unique to the use of the user device over the time period, and may indicate tendencies of the individual using the user device. In some implementations, the device metadata may further indicate an address that identifies the user device (e.g., an Internet Protocol (IP) address and/or a medium access control (MAC) address), a time (e.g., a time of day) of the login request, and/or a geographic location (e.g., a city or a state) of the user device at the time of the login request, among other examples.

As shown in FIG. 1C, and by reference number 125, the account device may determine whether the use of the user device is recognized for the user based on the device metadata. For example, the account device may compare the device metadata to historical use data (e.g., historical touch data and/or inertial measurement data relating to login requests) to determine whether the device metadata is consistent with the historical use data. As an example, if a use profile indicated by the historical use data differs from the use profile indicated by the device metadata (e.g., because during the login request the individual held the user device at a different angle, or used a harder touch pressure, than is typical for logins to the account), the account device may determine that the use is not recognized for the user.

In some implementations, the account device may determine whether the use of the user device is recognized for the user using a first user-specific machine learning model. For example, the first user-specific machine learning model may be trained to identify an anomalous use (or a consistent use) of the user device based on an input to the first user-specific machine learning model of the device metadata. In some implementations, the first user-specific machine learning model may be trained using training data that relates to one or more other user devices (e.g., the training data may not relate to the user device, or may relate to the user device and the other user device(s)). In particular, because the device metadata relates to how the user uses a user device, rather than to characteristics particular to the user device itself, the device metadata is independent of any specific user device. Thus, device metadata relating to another user device is also relevant to the use of the user device. In this way, the device metadata is resilient to the user changing user devices, and therefore can be used for highly accurate authentication with reduced false negatives.

Responsive to a determination that the use of the user device is recognized for the user, the account device may authorize the user to log in to the account, as described below. However, as shown in FIG. 1D, and by reference number 130, responsive to a determination that the user device is not recognized for the user (e.g., the log in request may be associated with a fraudulent SIM swap), the account device may cause the user device to provide (e.g., display) a prompt for inputting a handwriting sample. For example, the account device may transmit an indication for the user device (e.g., via a web page or a mobile application) indicating that the use is not recognized, and the indication may cause the user device to provide the prompt for inputting the handwriting sample. As another example, the account device may transmit an instruction for the user device (e.g., via a web page or a mobile application) to provide the prompt for inputting the handwriting sample, and the instruction may cause the user device to provide the prompt for inputting the handwriting sample. The prompt for inputting the handwriting sample may include an input element in which the individual can input writing using a touchscreen of the user device (e.g., using the individual's finger or a stylus). In some implementations, the handwriting sample may be for an item that is known and repeatable, such as a signature sample.

As shown by reference number 135, the account device may determine input metadata relating to an inputting of the handwriting sample to the user device. For example, the input metadata may relate to a time period during which the handwriting sample is being inputted, or to a time period starting from the prompt for inputting the handwriting sample being provided and ending when the handwriting sample has been completely inputted. In some implementations, the input metadata may include an input pressure used for the handwriting sample and/or an input speed used for the handwriting sample, among other examples.

To determine the input metadata, the account device may obtain touch data (e.g., indicating touch activity, tapping activity, swiping activity, and/or other touch gesture activity on a touchscreen of the user device), among other examples. For example, the user device may capture sensor data from one or more sensors of the user device (e.g., a touch sensor or the like), generate the touch data, and report the touch data to the account device. In some implementations, the reported touch data may be or may include the sensor data.

The account device may analyze the touch data to determine the input metadata. In some examples, the user device may analyze the touch data, and provide the input metadata to the account device (e.g., to determine the input metadata, the account device may receive the input metadata from the user device). The input metadata may indicate an input profile associated with inputting the writing sample. This input profile may indicate a time series of touch gestures performed on the user device, a quantity of touch gestures performed (e.g., broken down by type of touch gestures), an average touch pressure of the touch gestures, an average touch length of the touch gestures, and/or an average movement distance of the touch gestures, among other examples. Thus, the input profile may be unique to the inputting of the handwriting sample, and may indicate writing tendencies of the individual using the user device. In some implementations, the account device may also receive an image of the handwriting sample from the user device.

As shown in FIG. 1E, and by reference number 140, the account device may determine whether the handwriting sample is valid for the user based on the input metadata and the image of the handwriting sample. For example, the account device may compare the input metadata to historical input data (e.g., historical touch data relating to inputting of handwriting samples), and compare the image of the handwriting sample to one or more specimen images (e.g., images of handwriting samples verified to have come from the user), to determine whether the input metadata is consistent with the historical input data and whether the image of the handwriting sample is consistent with the specimen image(s). As an example, if an input profile indicated by the historical input data differs from the input profile indicated by the input metadata (e.g., because during the inputting of the handwriting sample the individual used a different writing speed or writing touch pressure than is typical for handwriting sample inputs for the account), the account device may determine that the handwriting sample is not valid for the user.

In some implementations, the account device may determine whether the handwriting sample is valid for the user using a second user-specific machine learning model. For example, the second user-specific machine learning model may be trained to identify an anomalous handwriting sample (or a consistent handwriting sample) based on an input of the input metadata and the image of the handwriting sample. In some implementations, the account device may have previously activated the second user-specific machine learning model for the user. For example, initially, the account device may have only a single handwriting sample from the user (e.g., provided at a time of account registration), and therefore the account device may use a non-user-specific machine learning model (e.g., a general machine learning model applicable across a plurality of users) for assessments of whether handwriting samples are valid for the user. The non-user-specific machine learning model may be configured to differentiate between writing samples that are inputted genuinely and/or by a human and writing samples that are inputted to copy another's handwriting and/or by a bot.

As the user provides handwriting samples in connection with multiple logins to the account, the account device (or another device) may provide images of the handwriting samples and corresponding input metadata to the second user-specific machine learning model as training data. Eventually, the account device may determine that a quantity of handwriting samples provided by the user satisfies a threshold for activating the second user-specific machine learning model. Thus, responsive to the quantity of handwriting samples satisfying the threshold, the account device may deactivate the non-user-specific machine learning model, and activate the second user-specific machine learning model, for assessments of whether handwriting samples are valid for the user.

Responsive to a determination that the handwriting sample is not valid for the user, the account device may deny the login request. For example, the account device may cause the user device to load a document indicating that access to the account is denied and/or indicating customer service information. As another example, the account device may lock the account (e.g., deny any future login attempts to the account until ownership of the account is confirmed).

As shown in FIG. 1F, and by reference number 145, responsive to a determination that the handwriting sample is valid for the user, the account device may authorize the login request. In some implementations, to authorize the login request, the account device may generate a session token for the user device, where the session token enables the user device to access secure areas (e.g., of a website or a mobile application) associated with the account. Additionally, or alternatively, to authorize the login request, the account device may cause a cookie to be set on the user device, where the cookie enables the user device to access secure areas associated with the account. Additionally, or alternatively, to authorize the login request, the account device may cause the user device to load a document relating to the account (e.g., a document containing information relating to the account). In some implementations, based on authorizing the login request (e.g., the individual is the user associated with the account), the account device may use (or cause another device to use) the device metadata as training data for the first user-specific machine learning model and/or the input metadata as training data for the second user-specific machine learning model.

In some implementations, responsive to a determination that the handwriting sample is valid for the user, the account device may cause an authentication code to be sent to a telephone number associated with the user, in a similar manner as described above. In other words, rather than an authentication code being sent to the user device prior to inputting of the handwriting sample, an authentication code may be sent to the user device after validation of the handwriting sample. Thus, computing resources and network resources associated with transmission of a text message or an automated phone call containing the authentication code can be conserved if the handwriting sample is determined to be invalid. After the authentication code is sent to the telephone number, the account device may receive an additional login request that indicates the authentication code. Accordingly, the account device may authorize the additional login request, as described above, responsive to a determination that the handwriting sample is valid for the user and responsive to the additional login request indicating the correct authentication code.

In this way, the user authentication techniques described herein are resilient to SIM swapping attacks or other unauthorized use of the user device or telephone number. Accordingly, techniques described herein improve network security and data security. Furthermore, techniques described herein conserve computing resources (e.g., processor resources and/or memory resources) that otherwise would be used toward identifying security incidents, investigating security incidents, blocking unauthorized access, correcting fraudulent activity, or the like.

As indicated above, FIGS. 1A-1F are provided as an example. Other examples may differ from what is described with regard to FIGS. 1A-1F.

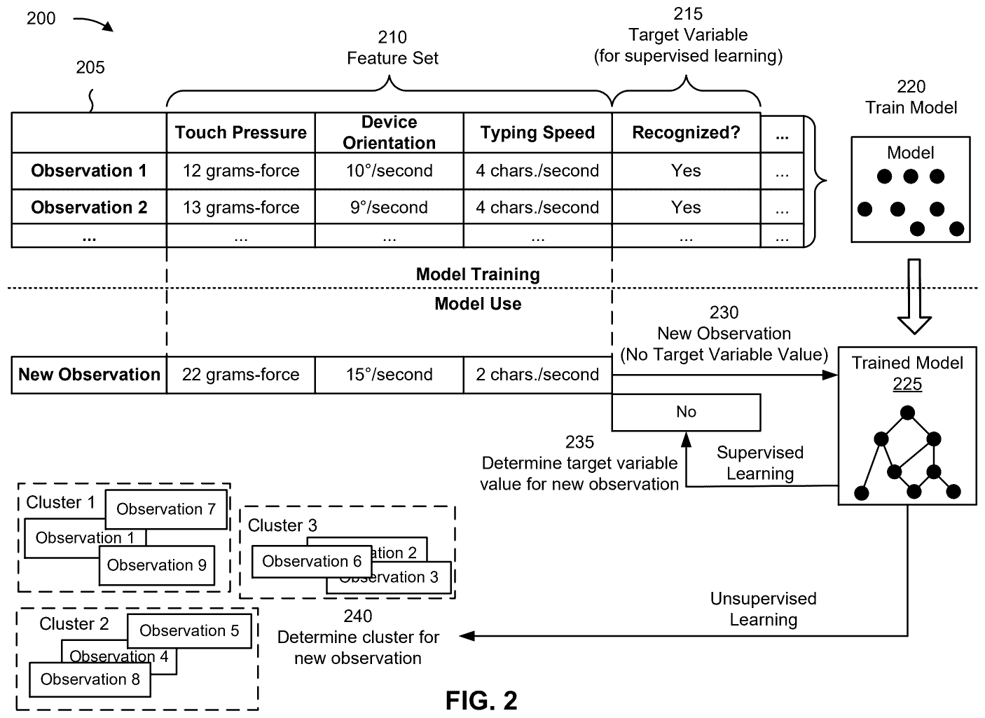

FIG. 2 is a diagram illustrating an example 200 of training and using a machine learning model in connection with device-independent user authentication. The machine learning model training and usage described herein may be performed using a machine learning system. The machine learning system may include or may be included in a computing device, a server, a cloud computing environment, or the like, such as the account device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the account device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a user device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of touch pressure, a second feature of device orientation, a third feature of typing speed, and so on. As shown, for a first observation, the first feature may have a value of 12 grams-force, the second feature may have a value of 10° per second, the third feature may have a value of 4 characters per second, and so on. These features and feature values are provided as examples, and may differ in other examples. For example, the feature set may include one or more of the following features: touch pressure (e.g., average touch pressure and/or a time series), device orientation (e.g., rate of rotation, a most-common orientation, and/or a time series of orientations), typing speed, a quantity of touch gestures performed per time unit (e.g., per second or per minute), an average touch length of the touch gestures, or an average movement distance of the touch gestures, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is whether a user of a user device is recognized, which has a value of “yes” for the first observation.

The feature set and target variable described above are provided as examples, and other examples may differ from what is described above. For example, for a target variable of whether a handwriting sample is valid, the feature set may include writing touch pressure, writing speed, total input time, device orientation during input, finger angle, number of finger lifts from touchscreen, an image of the handwriting sample, or the like.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, using a neural network algorithm, the machine learning system may train a machine learning model to output (e.g., at an output layer) a recognized or not recognized indication based on an input (e.g., at an input layer) of device metadata relating to a use of a user device, as described elsewhere herein. In particular, the machine learning system, using the neural network algorithm, may train the machine learning model, using the set of observations from the training data, to derive weights for one or more nodes in the input layer, in the output layer, and/or in one or more hidden layers (e.g., between the input layer and the output layer). Nodes in the input layer may represent features of a feature set of the machine learning model, such as a first node representing touch pressure, a second node representing device orientation, a third node representing typing speed, and so forth. One or more nodes in the output layer may represent output(s) of the machine learning model, such as a node indicating the recognized or not recognized indication. The weights learned by the machine learning model facilitate transformation of the input of the machine learning model to the output of the machine learning model. After training, the machine learning system may store the machine learning model as a trained machine learning model 225 to be used to analyze new observations.

As an example, the machine learning system may obtain training data for the set of observations from device metadata, input metadata, and/or handwriting sample images each time an authorized user logs into an account, as described herein.

As shown by reference number 230, the machine learning system may apply the trained machine learning model 225 to a new observation, such as by receiving a new observation and inputting the new observation to the trained machine learning model 225. As shown, the new observation may include a first feature value of 22 grams-force, a second feature value of 15° per second, a third feature value of 2 characters per second, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “no” for the target variable of whether a user device is recognized for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first automated action may include, for example, causing the user device to provide a prompt for inputting a handwriting sample.

As another example, if the machine learning system were to predict a value of “yes” for the target variable of whether the user device is recognized, then the machine learning system may provide a second (e.g., different) recommendation and/or may perform or cause performance of a second (e.g., different) automated action (e.g., causing the user device to load a document relating to the account).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., recognized), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., not recognized), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include data indicating whether a login attempt was ultimately successful or unsuccessful.

In this way, the machine learning system may apply a rigorous and automated process for user authentication based on use of a user device and/or a handwriting sample. The machine learning system may enable recognition and/or identification of tens, hundreds, thousands, or millions of features and/or feature values for tens, hundreds, thousands, or millions of observations, thereby increasing accuracy and consistency and reducing delay associated with user authentication relative to requiring computing resources to be allocated for tens, hundreds, or thousands of operators to manually perform user authentication using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a user device 310, an account device 320, and a network 330. Devices of environment 300 may interconnect via wired connections, wireless connections, or a combination of wired and wireless connections.

The user device 310 may include one or more devices capable of receiving, generating, storing, processing, and/or providing information associated with device-independent user authentication, as described elsewhere herein. The user device 310 may include a communication device and/or a computing device. For example, the user device 310 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The account device 320 may include one or more devices capable of receiving, generating, storing, processing, providing, and/or routing information associated with device-independent user authentication, as described elsewhere herein. The account device 320 may include a communication device and/or a computing device. For example, the account device 320 may include a server, such as an application server, a client server, a web server, a database server, a host server, a proxy server, a virtual server (e.g., executing on computing hardware), or a server in a cloud computing system. In some implementations, the account device 320 may include computing hardware used in a cloud computing environment.

The network 330 may include one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with device-independent user authentication. The device 400 may correspond to user device 310 and/or account device 320. In some implementations, user device 310 and/or account device 320 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

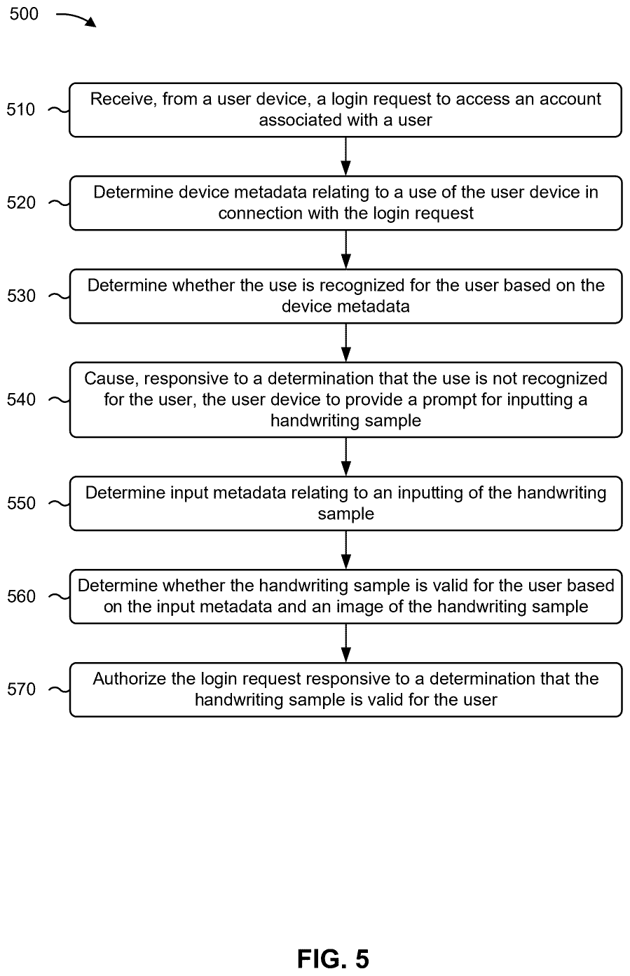

FIG. 5 is a flowchart of an example process 500 associated with device-independent user authentication. In some implementations, one or more process blocks of FIG. 5 may be performed by the account device 320. In some implementations, one or more process blocks of FIG. 5 may be performed by another device or a group of devices separate from or including the account device 320, such as the user device 310. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a login request to access an account associated with a user (block 510). For example, the account device 320 (e.g., using processor 420, memory 430, input component 440, and/or communication component 460) may receive, from a user device, a login request to access an account associated with a user, as described above in connection with reference number 115 of FIG. 1B. As an example, the login request may indicate the authentication code that was sent to the user device (e.g., an SMS OTP).

As further shown in FIG. 5, process 500 may include determining device metadata relating to a use of the user device in connection with the login request (block 520). For example, the account device 320 (e.g., using processor 420 and/or memory 430) may determine device metadata relating to a use of the user device in connection with the login request, as described above in connection with reference number 120 of FIG. 1B. As an example, the device metadata may be determined responsive to the login request indicating a correct authentication code. In some implementations, the device metadata may indicate an orientation of the user device, a touch pressure of inputs to the user device, and/or a typing speed on the user device, among other examples.

As further shown in FIG. 5, process 500 may include determining whether the use is recognized for the user based on the device metadata (block 530). For example, the account device 320 (e.g., using processor 420 and/or memory 430) may determine whether the use is recognized for the user based on the device metadata, as described above in connection with reference number 125 of FIG. 1C. As an example, whether the use of the user device is recognized for the user may be determined using a first user-specific machine learning model.

As further shown in FIG. 5, process 500 may include causing, responsive to a determination that the use is not recognized for the user, the user device to provide a prompt for inputting a handwriting sample (block 540). For example, the account device 320 (e.g., using processor 420, memory 430, output component 450, and/or communication component 460) may cause, responsive to a determination that the use is not recognized for the user, the user device to provide a prompt for inputting a handwriting sample, as described above in connection with reference number 130 of FIG. 1D. As an example, the prompt for inputting the handwriting sample may include an input element in which an individual can input writing using a touchscreen of the user device (e.g., using the individual's finger or a stylus).

As further shown in FIG. 5, process 500 may include determining input metadata relating to an inputting of the handwriting sample (block 550). For example, the account device 320 (e.g., using processor 420 and/or memory 430) may determine input metadata relating to an inputting of the handwriting sample, as described above in connection with reference number 135 of FIG. 1D. As an example, the input metadata may include an input pressure used for the handwriting sample and/or an input speed used for the handwriting sample, among other examples.

As further shown in FIG. 5, process 500 may include determining whether the handwriting sample is valid for the user based on the input metadata and an image of the handwriting sample (block 560). For example, the account device 320 (e.g., using processor 420 and/or memory 430) may determine whether the handwriting sample is valid for the user based on the input metadata and an image of the handwriting sample, as described above in connection with reference number 140 of FIG. 1E. As an example, whether the handwriting sample is valid for the user may be determined using a second user-specific machine learning model.

As further shown in FIG. 5, process 500 may include authorizing the login request responsive to a determination that the handwriting sample is valid for the user (block 570). For example, the account device 320 (e.g., using processor 420, memory 430, output component 450, and/or communication component 460) may authorize the login request responsive to a determination that the handwriting sample is valid for the user, as described above in connection with reference number 145 of FIG. 1F. As an example, authorizing the login request may include generating a session token for the user device, where the session token enables the user device to access secure areas (e.g., of a website or a mobile application) associated with the account.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for device-independent user authentication, the system comprising:
one or more memories; and
one or more processors, communicatively coupled to the one or more memories, configured to:
receive, from a user device, a login request to access an account associated with a user;
determine device metadata relating to a use of the user device in connection with the login request,
wherein the device metadata includes one or more of: an orientation of the user device, a touch pressure of inputs to the user device, or a typing speed on the user device;
determine, using a first user-specific machine learning model, whether the use is recognized for the user based on the device metadata;
cause, responsive to a determination that the use is not recognized for the user, the user device to provide a prompt for inputting a handwriting sample;
determine input metadata relating to an inputting of the handwriting sample,
wherein the input metadata includes one or more of: an input pressure used for the handwriting sample or an input speed used for the handwriting sample;
determine, using a second user-specific machine learning model, whether the handwriting sample is valid for the user based on the input metadata and an image of the handwriting sample; and
authorize the login request responsive to a determination that the handwriting sample is valid for the user.

2. The system of claim 1, wherein the handwriting sample is a signature sample.

3. The system of claim 1, wherein the one or more processors are further configured to:
identify that a quantity of handwriting samples provided by the user satisfies a threshold;
deactivate, responsive to the quantity of handwriting samples satisfying the threshold, a non-user-specific machine learning model for assessments of whether handwriting samples are valid for the user; and
activate, responsive to the quantity of handwriting samples satisfying the threshold, the second user-specific machine learning model for assessments of whether handwriting samples are valid for the user.

4. The system of claim 1, wherein the one or more processors, to authorize the login request, are configured to:
generate a session token for the user device;
cause a cookie to be set on the user device; or
cause the user device to load a document relating to the account.

5. The system of claim 1, wherein the one or more processors, to determine the device metadata, are configured to:
obtain, from the user device, at least one of touch data or inertial measurement data; and
determine the device metadata based on the at least one of the touch data or the inertial measurement data.

6. The system of claim 1, wherein the one or more processors, to determine the input metadata, are configured to:
obtain, from the user device, touch data; and
determine the input metadata based on the touch data.

7. The system of claim 1, wherein the first user-specific machine learning model is trained using training data that relates to another user device.

8. The system of claim 1, wherein the first user-specific machine learning model is trained to identify an anomalous use of the user device based on an input of the device metadata.

9. The system of claim 1, wherein the second user-specific machine learning model is trained to identify an anomalous handwriting sample based on an input of the input metadata.

10. A method of device-independent user authentication, comprising:
receiving, by a device and from a user device, a login request to access an account associated with a user;
determining device metadata relating to a use of the user device in connection with the login request;
determining whether the use is recognized for the user based on the device metadata;
causing, responsive to a determination that the use is not recognized for the user, the user device to provide a prompt for inputting a handwriting sample;
determining input metadata relating to an inputting of the handwriting sample;
determining whether the handwriting sample is valid for the user based on the input metadata and an image of the handwriting sample; and
authorizing the login request responsive to a determination that the handwriting sample is valid for the user.

11. The method of claim 10, wherein the device metadata includes one or more of: an orientation of the user device, a touch pressure of inputs to the user device, or a typing speed on the user device.

12. The method of claim 11, wherein the device metadata further includes one or more of:
an address that identifies the user device,
a time of the login request, or
a geographic location of the user device at the time of the login request.

13. The method of claim 10, wherein the input metadata includes one or more of: an input pressure used for the handwriting sample or an input speed used for the handwriting sample.

14. The method of claim 10, wherein the login request indicates an authentication code sent to the user device.

15. The method of claim 10, wherein determining whether the use is recognized for the user is determined using a first user-specific machine learning model, and
wherein determining whether the handwriting sample is valid for the user is determined using a second user-specific machine learning model.

16. The method of claim 10, further comprising:
causing, responsive to the determination that the handwriting sample is valid for the user, an authentication code to be sent to a telephone number associated with the user; and
receiving an additional login request that indicates the authentication code,
wherein authorizing the login request comprises authorizing the login request responsive to the determination that the handwriting sample is valid for the user and responsive to the additional login request indicating the authentication code.

17. A non-transitory computer-readable medium storing a set of instructions for device-independent user authentication, the set of instructions comprising:
one or more instructions that, when executed by one or more processors of a device, cause the device to:
determine device metadata relating to a use of a user device;
determine whether the use is recognized based on the device metadata;
cause, responsive to a determination that the use is not recognized, the user device to provide a prompt for inputting a handwriting sample;
determine input metadata relating to an inputting of the handwriting sample; and
determine whether the handwriting sample is valid based on the input metadata and an image of the handwriting sample.

18. The non-transitory computer-readable medium of claim 17, wherein the one or more instructions, when executed by the one or more processors, further cause the device to:
receive, from the user device, an initial login request to access an account;
cause, responsive to the initial login request, an authentication code to be sent to a telephone number associated with the account; and
receive, from the user device, a login request to access the account,
wherein the login request indicates the authentication code.

19. The non-transitory computer-readable medium of claim 17, wherein the one or more instructions, when executed by the one or more processors, further cause, responsive to a determination that the handwriting sample is valid, the device to:
generate a session token for the user device;
cause a cookie to be set on the user device; or
cause the user device to load a document relating to an account.

20. The non-transitory computer-readable medium of claim 17, wherein the device metadata includes one or more of: an orientation of the user device, a touch pressure of inputs to the user device, or a typing speed on the user device, and
wherein the input metadata includes one or more of: an input pressure used for the handwriting sample or an input speed used for the handwriting sample.
